(19) United States
(12) Patent Application Publication
(10) Pub. No.: US 2015/0132666 A1
(43) Pub. Date: May 14, 2015

(54) POSITIVE ELECTRODE FOR NON-AQUEOUS ELECTROLYTE SECONDARY BATTERY, AND NON-AQUEOUS ELECTROLYTE SECONDARY BATTERY

(71) Applicant: SANYO Electric Co., Ltd., Moriguchi-shi, Osaka (JP)

(72) Inventors: Atsushi Ogata, Hyogo (JP); Takeshi Ogasawara, Hyogo (JP); Yasufumi Takahashi, Hyogo (JP); Motoharu Saito, Hyogo (JP); Masaki Hirase, Hyogo (JP); Katsunori Yanagida, Hyogo (JP); Masahisa Fujimoto, Hyogo (JP)

(73) Assignee: SANYO ELECTRIC CO., LTD., Moriguchi-shi, Osaka (JP)

(21) Appl. No.: 14/369,925

(22) PCT Filed: Dec. 28, 2012
(86) PCT No.: PCT/JP2012/084050

§ 371 Date: Jun. 30, 2014

(30) Foreign Application Priority Data
Jan. 17, 2012 (JP) 2012-007057

(51) Int. Cl. H01M 4/36; H01M 10/0525; H01M 10/0569; H01M 4/485; H01M 4/131; H01M 4/505

(52) U.S. Cl. CPC H01M 4/366; H01M 4/131; H01M 4/505; H01M 10/0569; H01M 4/485; H01M 10/0525
USPC 429/338; 429/231.1; 429/224; 429/341; 429/342; 429/343

(57) ABSTRACT

There is provided a positive electrode for a nonaqueous electrolyte secondary battery, the positive electrode being capable of improving the charge-discharge cycle characteristics of the nonaqueous electrolyte secondary battery. A positive electrode 12 of a nonaqueous electrolyte secondary battery 1 contains positive electrode active material particles. The positive electrode active material particles contain a lithium-containing transition metal oxide. The lithium-containing transition metal oxide has a crystal structure that belongs to the space group P6₃mc. A compound of at least one selected from the group consisting of boron, zirconium, aluminum, magnesium, titanium, and a rare-earth element is attached to surfaces of the positive electrode active material particles.

### TECHNICAL FIELD

The present invention relates to a positive electrode for a nonaqueous electrolyte secondary battery, and a nonaqueous electrolyte secondary battery.

### BACKGROUND ART

In recent years, nonaqueous electrolyte secondary batteries, such as lithium batteries, have been widely used as power supplies for electronic equipment and so forth. Lithium cobaltate (LiCoO₂) specified by the O3 structure that belongs to the space group R-3m is commonly used as a positive electrode active material for a lithium battery.

However, LiCoO₂ specified by the O3 structure has the following problem: For example, When charging is performed to about 4.6 V (vs. Li/Li⁺), about 70% or more of lithium is deintercalated from LiCoO₂ in a positive electrode. At this time, the crystal structure of LiCoO₂ collapses, thereby reducing the reversibility of intercalation-deintercalation of lithium in charge-discharge cycles.

LiCoO₂ having the O2 structure that belongs to the space group P6₃mc is also known (for example, see PTL 1).

### CITATION LIST

### Patent Literature

PTL 1: Japanese Published Unexamined Patent Application No. 2011-228273

### SUMMARY OF INVENTION

### Technical Problem

It is known that even if about 80% of lithium in LiCoO₂ having the O2 structure that belongs to the space group P6₃mc is deintercalated, the crystal structure of LiCoO₂ is maintained, so that charging and discharging can be performed. However, even in the case where LiCoO₂ having the O2 structure that belongs to the space group P6₃mc is used, for example, when charging is performed to about 4.6 V (vs. Li/Li⁺), the charge-discharge cycle characteristics are degraded, in some cases.

It is a main object of the present invention to provide a positive electrode for a nonaqueous electrolyte secondary battery, the positive electrode being capable of improving the charge-discharge cycle characteristics of the nonaqueous electrolyte secondary battery.

### Solution to Problem

According to the present invention, a positive electrode for a nonaqueous electrolyte secondary battery contains positive electrode active material particles. The positive electrode active material particles contain a lithium-containing transition metal oxide. The lithium-containing transition metal oxide has a crystal structure that belongs to the space group P6₃mc. A compound containing at least one selected from the group consisting of boron, zirconium, aluminum, magnesium, titanium, and a rare-earth element is attached to surfaces of the positive electrode active material particles.

The nonaqueous electrolyte secondary battery of the present invention includes the foregoing positive electrode, a negative electrode, a nonaqueous electrolyte, and a separator.

### Advantageous Effects of Invention

According to the present invention, it is possible to provide a positive electrode for a nonaqueous electrolyte secondary battery, the positive electrode being capable of the charge-discharge cycle characteristics of the nonaqueous electrolyte secondary battery.

### BRIEF DESCRIPTION OF DRAWINGS

FIG. 1 is a schematic cross-sectional view of a lithium secondary battery according to an embodiment of the present invention.

FIG. 2 is a schematic cross-sectional view of a positive electrode of a lithium secondary battery according to an embodiment of the present invention.

FIG. 3 is a schematic cross-sectional view of a positive electrode of a lithium secondary battery according to an embodiment of the present invention.

### DESCRIPTION OF EMBODIMENTS

While preferred embodiments of the present invention will be described below, the following embodiments are merely illustrative. The present invention is not limited to these embodiments.

The drawings to be referred in the embodiments are schematically illustrated. The dimensional ratios and so forth of objects depicted in the drawings may differ from those of the actual objects. The dimensional ratios and so forth of specific physical objects should be determined in consideration of the following description.

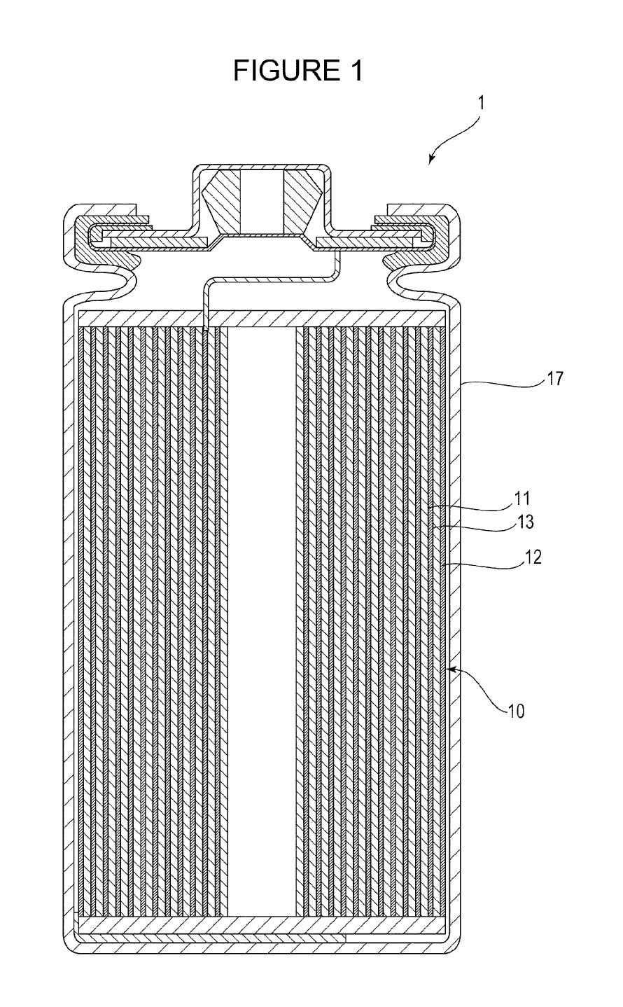

As illustrated in FIG. 1, a nonaqueous electrolyte secondary battery 1 includes a battery case 17. In this embodiment, the battery case 17 has a cylindrical shape. In the present invention, however, the shape of the battery case is not limited to a cylindrical shape. For example, the battery case may have a flat shape or rectangular shape.

An electrode member 10 impregnated with a nonaqueous electrolyte is contained in the battery case 17.

As the nonaqueous electrolyte, for example, a known nonaqueous electrolyte may be used. The nonaqueous electrolyte includes a solute, a nonaqueous solvent, and so forth.

Preferred examples of the solute of the nonaqueous electrolyte include LiXF_{y} (wherein in the formula, X represents P, As, Sb, B, Bi, Al, Ga, or In; when X represents P, As, or Sb, y represents 6; and when X represents B, Bi, Al, Ga, or In, y represents 4), lithium perfluoroalkylsulfonylimide LiN(CₘF₂ₘ₊₁SO₂) (CₙF₂ₙ₊₁SO₂) (where in the formula, m and n each independently represent an integer of 1 to 4), lithium perfluoroalkylsulfonylmethide LiC(CₚF₂ₚ₊₁SO₂) (C_{q}F_{2q+1}SO₂) (CᵣF₂ᵣ₊₁SO₂) (where in the formula, p, q, and r each independently represent an integer of 1 to 4), LiCF₃SO₃, LiClO₄, Li₂B₁₀Cl₁₀, and Li₂B₁₂Cl₁₂. Among these compounds, LiPF₆, LiBF₄, LiN(CF₃SO₂)₂, LiN(C₂F₅SO₂)₂, LiN(CF₃SO₂) (C₄F₉SO₂), LiC(CF₃SO₂)₃, LiC(C₂F₅SO₂)₃, and so forth are preferred as the solute.

The nonaqueous electrolyte may contain a single type of solute or may contain a plurality of solutes.

Examples of the nonaqueous solvent of the nonaqueous electrolyte include a fluorine-containing cyclic carbonate and a fluorine-containing chain ester.

As the fluorine-containing cyclic carbonate, a fluorine-containing cyclic carbonate in which a fluorine atom is directly bonded to a carbonate ring is preferred. Specific examples of the fluorine-containing cyclic carbonate include 4-fluoroethylene carbonate, 4,5-difluoroethylene carbonate, 4,4-difluoroethylene carbonate, 4,4,5-trifluoroethylene carbonate, and 4,4,5,5-tetrafluoroethylene carbonate. Among these compounds, 4-fluoroethylene carbonate and 4,5-difluoroethylene carbonate are more preferred because their relatively low viscosities facilitate the formation of a protective film on a surface of a negative electrode.

The fluorine-containing cyclic carbonate is preferably contained in the nonaqueous solvent in an amount of about 5% by volume to about 50% by volume and more preferably about 10% by volume to about 30% by volume.

Examples of the fluorine-containing chain ester include a fluorine-containing chain carboxylate and a fluorine-containing chain carbonate.

Examples of the fluorine-containing chain carboxylate include substitution products of methyl acetate, ethyl acetate, propyl acetate, methyl propionate, and ethyl propionate, in which at least one of the hydrogen atoms of each of the substitution products is replaced with fluorine. Among these compounds, methyl 3,3,3-trifluoropropionate and 2,2,2-trifluoroethyl acetate are preferred because each of them has a relatively low viscosity, so when it is used in combination with the foregoing fluorine-containing cyclic carbonate or a lithium-containing transition metal oxide described below, a satisfactory protective film is formed on a surface of a positive electrode.

Examples of the fluorine-containing chain carbonate include substitution products of, for example, dimethyl carbonate, ethyl methyl carbonate, diethyl carbonate, methyl propyl carbonate, ethyl propyl carbonate, and methyl isopropyl carbonate, in which at least one of the hydrogen atoms of each of the substitution products is replaced with fluorine. Among these compounds, methyl 2,2,2-trifluoroethyl carbonate is preferred because when it is used in combination with a lithium-containing transition metal oxide described below, a satisfactory protective film is formed on a positive electrode.

The fluorine-containing chain ester is preferably contained in the nonaqueous solvent in an amount of about 30% by volume to about 90% by volume and more preferably about 50% by volume to about 90% by volume. Methyl 2,2,2-trifluoroethyl carbonate is more preferably contained in the nonaqueous solvent in an amount of about 1% by volume to about 40% by volume and still more preferably about 5% by volume to about 20% by volume.

The nonaqueous solvent preferably contains either the fluorine-containing cyclic carbonate or the fluorine-containing chain ester, and more preferably contains both the fluorine-containing cyclic carbonate and the fluorine-containing chain ester.

As the nonaqueous solvent other than the fluorine-containing cyclic carbonate and the fluorine-containing chain ester, nonaqueous solvents commonly used for nonaqueous electrolyte secondary batteries may be used. Specific examples of the nonaqueous solvent that may be contained include cyclic carbonates, chain carbonates, carboxylates, cyclic ethers, chain ethers, nitriles, amides, and solvent mixtures thereof.

Examples of cyclic carbonates include ethylene carbonate, propylene carbonate, and butylene carbonate.

Examples of chain carbonates include dimethyl carbonate, ethyl methyl carbonate, diethyl carbonate, methyl propyl carbonate, ethyl propyl carbonate, and methyl isopropyl carbonate.

Examples of carboxylates include methyl acetate, ethyl acetate, propyl acetate, methyl propionate, ethyl propionate, and γ-butyrolactone.

Examples of cyclic ethers include 1,3-dioxolan, 4-methyl-1,3-dioxolan, tetrahydrofuran, 2-methyltetrahydrofuran, propylene oxide, 1,2-butylene oxide, 1,3-dioxane, 1,4-dioxane, 1,3,5-trioxane, furan, 2-methylfuran, 1,8-cineole, and crown ethers.

Examples of chain ethers include 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxytoluene, benzyl ethyl ether, diphenyl ether, dibenzyl ether, o-dimethoxybenzene, 1,2-diethoxyethane, 1,2-dibutoxyethane, diethylene glycol dimethyl ether, diethylene glycol diethyl ether, diethylene glycol dibutyl ether, 1,1-dimethoxymethane, 1,1-diethoxyethane, triethylene glycol dimethyl ether, and tetraethylene glycol dimethyl.

An example of nitriles is acetonitrile. An example of amides is dimethylformamide.

The electrode member 10 includes a negative electrode 11, a positive electrode 12, and a separator 13 provided between the negative electrode 11 and the positive electrode 12, the negative electrode 11, the positive electrode 12, and the separator 13 being rolled.

The separator 13 is not particularly limited as long as it inhibits a short circuit due to the contact between the negative electrode 11 and the positive electrode 12 and it is impregnated with the nonaqueous electrolyte to provide lithium-ion conductivity. The separator 13 may be formed of, for example, a porous resin film. Specific examples of the porous resin film include a porous polypropylene film, a porous polyethylene film, and a laminate of the porous polypropylene film and the polyethylene film.

The negative electrode 11 includes a negative electrode collector and a negative electrode active material layer disposed on at least one surface of the negative electrode collector. The negative electrode collector may be formed of, for example, foil composed of a metal, such as Cu, or an alloy containing a metal, such as Cu.

The negative electrode active material layer contains negative electrode active material particles. The negative electrode active material particles are not particularly limited as long as they can reversibly intercalate and deintercalate lithium. The negative electrode active material particles are composed of, for example, a carbon material, a material that can be alloyed with lithium, or a metal oxide, such as tin oxide. Specific examples of the carbon material include natural graphite, artificial graphite, mesophase pitch-based carbon fibers (MCF), mesocarbon microbeads (MCMB), coke, hard carbon, fullerene, and carbon nanotubes. Examples of the material that can be alloyed with lithium include one or more metals selected from the group consisting of silicon, germanium, tin, and aluminum; and alloys containing one or more metal selected from the group consisting of silicon, germanium, tin, and aluminum. The negative electrode active material particles preferably contain at least one of silicon and silicon alloys. A specific example of the negative electrode active material particles containing at least one of silicon and silicon alloys is a polycrystalline silicon powder.

The negative electrode active material layer may contain a known carbon conductive agent, such as graphite, and a known binder, such as sodium carboxymethylcellulose (CMC) or styrene-butadiene rubber (SBR), and so forth.

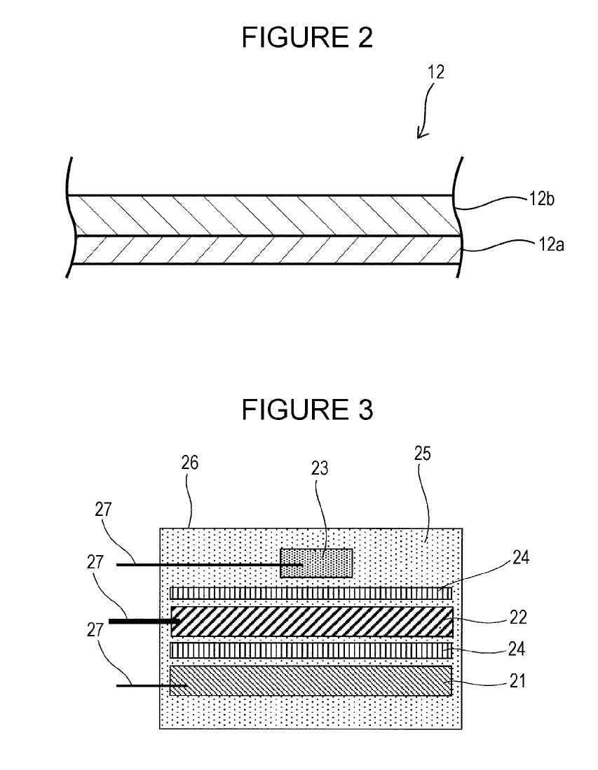

As illustrated in FIG. 2, the positive electrode 12 includes a positive electrode collector 12a and a positive electrode active material layer 12b disposed on the positive electrode collector 12a. The positive electrode collector 12a may be composed of a metal, such as Al, or an alloy containing a metal, such as Al.

The positive electrode active material layer 12b contains positive electrode active material particles. The positive electrode active material layer 12b may contain an appropriate material, for example, a binder or a conductive agent, in addition to the positive electrode active material particles. Preferred examples of the binder include polytetrafluoroethylene and polyvinylidene fluoride.

Preferred examples of the conductive agent include carbon materials, such as graphite, acetylene black, and carbon black.

The positive electrode active material particles contain a lithium-containing transition metal oxide having a crystal structure (O2 structure) that belongs to the space group P6₃mc.

The positive electrode active material particles preferably contain a lithium-containing transition metal oxide represented by the general formula (1): Liₓ₁Na_{y1}Co_{α}M_{β}O_{γ} (where 0<x1≦1.1, 0<y1<0.05, 0.3≦α<1, 0<β≦0.25, 1.9≦γ≦2.1, and M represents a metal element other than Co). In the general formula (1), M preferably contains at least one of Mn and Ti from the viewpoint of stabilizing the structure of the lithium-containing transition metal oxide.

In the general formula (1), when x1 is more than 1.1, the transition metal site in the lithium-containing transition metal oxide is occupied by lithium to reduce the capacity density, in some cases. When y1 is 0.05 or more, the crystal structure of the lithium-containing transition metal oxide collapses readily at the time of the intercalation or deintercalation of lithium. When 0<y1<0.05, sodium is not detected by X-ray diffraction (XRD) analysis, in some cases. When α is less than 0.3, the average discharge potential of the lithium secondary battery 1 is reduced, in some cases. When α is 1 or more, the crystal structure of the lithium-containing transition metal oxide collapses readily when charging is performed until the positive electrode potential reaches 4.6 V (vs. Li/Li⁺) or more. When 0.5≦α<1, this range is preferred because the energy density of the lithium secondary battery 1 is further increased. When 0.75≦α<0.95, this range is more preferred. When β is more than 0.25, the discharge capacity density at 3.2 V or less is increased to reduce the average discharge potential of the lithium secondary battery 1.

The content of the lithium-containing transition metal oxide, which has the crystal structure (O2 structure) that belongs to the space group P6₃mc, in the positive electrode active material particles is preferably in the range of about 40% by mass to about 100% by mass, more preferably about 60% by mass to about 100% by mass, and still more preferably about 80% by mass to about 100% by mass.

The lithium-containing transition metal oxide may be produced by ion-exchanging part of sodium in sodium-containing transition metal oxide that contains lithium in an amount equal to or lower than the molar quantity of sodium for lithium. For example, the lithium-containing transition metal oxide may be produced by ion-exchanging part of sodium in sodium-containing transition metal oxide represented by the general formula (2): Liₓ₂Na_{y2}CoαMn_{β}O_{γ} (where 0<x2≦0.1, 0.66<y2<0.75, 0.3≦α<1, 0<0.25, and 1.9≦γ≦2.1) with lithium.

The positive electrode active material particles may further contain a lithium-containing transition metal oxide having a crystal structure that belongs to the space group C2/m, the space group C2/c, or the space group R-3m. Examples of the lithium-containing transition metal oxide having a crystal structure that belongs to the space group C2/m, the space group C2/c, or the space group R-3m, the lithium-containing transition metal oxide being to be contained possibly in the positive electrode active material particles, include Li₂MnO₃ and solid solutions thereof, LiCoO₂ having the O3 structure, LiNiₐCo_{b}Mn_{c}O₂ (where 0≦a≦1, 0≦b≦1, 0≦c≦1, and a+b+c=1).

A compound containing at least one element selected from the group consisting of boron, zirconium, aluminum, magnesium, titanium, and rare-earth elements is attached to surfaces of the positive electrode active material particles. As the rare-earth elements, neodymium, samarium, terbium, dysprosium, holmium, erbium, lutetium, and so forth are preferred. Neodymium, samarium, erbium, and so forth are more preferred.

The compound containing at least one element selected from the group consisting of boron, zirconium, aluminum, magnesium, titanium, and rare-earth elements is preferably attached in the form of at least one selected from the group consisting of hydroxide, oxyhydroxide, carbonate compounds, and phosphate compounds. Erbium hydroxide, erbium oxyhydroxide, aluminum hydroxide, and boron oxide, and so forth are preferably attached to the surfaces of the positive electrode active material particles.

The compound containing at least one element selected from the group consisting of boron, zirconium, aluminum, magnesium, titanium, and rare-earth elements may be attached to the surfaces of the positive electrode active material particles with the compound contained in particles, layers, or the like formed on the surfaces of the positive electrode active material particles.

The total mass of the foregoing elements is preferably in the range of about 0.01% by mass to about 5% by mass and more preferably about 0.02% by mass to about 1% by mass with respect to the total mass of the positive electrode active material particles and the compound containing the foregoing elements.

In the positive electrode 12 of the nonaqueous electrolyte secondary battery 1 according to this embodiment, the positive electrode active material particles contain a lithium-containing transition metal oxide having a crystal structure that belongs to the space group P6₃mc. Furthermore, a compound containing at least one selected from the group consisting of boron, zirconium, aluminum, magnesium, titanium, and rare-earth elements is attached to surfaces of the positive electrode active material particles. Thus, the positive electrode 12 of the nonaqueous electrolyte secondary battery 1 according to this embodiment can improve the charge-discharge cycle characteristics of the nonaqueous electrolyte secondary battery 1. The reason for this is presumably as follows: The compound is attached to the surfaces of the positive electrode active material particles containing the lithium-containing transition metal oxide having the crystal structure that belongs to the space group P6₃mc. This inhibits the decomposition of the nonaqueous electrolyte, thereby inhibiting a reduction in charge-discharge cycle characteristics due to the deposition of a decomposition product on the negative electrode 11.

An example of a method for attaching the compound containing at least one selected from the group consisting of boron, zirconium, aluminum, magnesium, titanium, and rare-earth elements to the positive electrode active material particles is a method including a first step of attaching the compound containing at least one selected from the group consisting of boron, zirconium, aluminum, magnesium, titanium, and rare-earth elements to LiCoO₂ having the O2 structure that belongs to the space group P6₃mc and a second step of performing heat treatment at a heat-treatment temperature of 300° C. or lower. Examples of a method that may be employed for the first step include a method in which a solution in which LiCoO₂ having the O2 structure that belongs to the space group P6₃mc is dispersed is mixed with a solution in which a salt of at least one selected from the group consisting of boron, zirconium, aluminum, magnesium, titanium, and rare-earth elements is dissolved in, for example, water; and a method in which a solution in which at least one selected from the group consisting of boron, zirconium, aluminum, magnesium, titanium, and rare-earth elements is dissolved is sprayed on the LiCoO₂ having the O2 structure that belongs to the space group P6₃mc.

In the heat treatment of the second step, the heat-treatment temperature is preferably 300° C. or lower. This is because at a heat-treatment temperature of more than 300° C., the phase of the LiCoO₂ having the O2 structure can be changed to the O3 structure. The lower limit temperature is preferably 80° C. or higher. This is because a lower limit temperature of less than 80° C. is likely to cause the decomposition reaction of the electrolyte due to adsorbed water.

In the first step, for example, a solution of a sulfate compound or a nitrate compound of a rare-earth element dissolved in water, or a solution of oxide or the like dissolved in an acidic aqueous solution of sulfuric acid, nitric acid, hydrochloric acid, acetic acid, or phosphoric acid is added in multiple portions to a solution of LiCoO₂ having the O2 structure dispersed in water. The resulting dispersion is maintained at a constant pH, thereby providing a product in which a rare-earth hydroxide is attached to the surface of LiCoO₂ having the O2 structure. A sufficient amount attached can result in the formation of a layer. At this time, the pH is preferably controlled in the range of 7 to 10, in particular, 7 to 9.5. A pH of less than 7 can cause the active material to be exposed to the acidic solution, thereby partially eluting cobalt. A pH of more than 10 is liable to cause the rare-earth compound attached to the surface of the active material to segregate, so that the rare-earth compound is not uniformly attached to the surface of the active material. This reduces the effect of inhibiting the side reaction between the electrolytic solution and LiCoO₂ having the O2 structure.

In the heat treatment of the second step, hydroxide attached to the surface changes, depending on the temperature. The hydroxide changes into oxyhydroxide in the temperature range of about 200° C. to about 300° C. and further changes into oxide in the temperature range of about 400° C. to about 500° C. Thus, a product in which hydroxide or oxyhydroxide is attached to the surface of LiCoO₂ having the O2 structure is preferably used.

In the first step, for example, a method may be employed in which a solution of an acetate compound or sulfate compound of a rare-earth element dissolved in water, or a solution of oxide or the like dissolved in an acidic aqueous solution of sulfuric acid, nitric acid, hydrochloric acid, acetic acid, or phosphoric acid is sprayed on LiCoO₂ having the O2 structure under stirring.

In this case, LiCoO₂ having the O2 structure is alkaline, so the attached compound rapidly changes into a hydroxide. Thus, a change in the temperature in the heat treatment of the second step allows the hydroxide on the surface to change into an oxyhydroxide or an oxide as described above.

An example of a method for producing a positive electrode active material according to this embodiment is a method for producing a positive electrode active material including a step of preparing a dispersion of a positive electrode active material particles dispersed in water; and a step of attaching the compound to the surfaces of the positive electrode active material particles by mixing a solution in which a salt containing at least one selected from the group consisting of zirconium, aluminum, magnesium, and rare-earth elements is dissolved, with the dispersion while the pH is controlled.

As described above, it is known that even if about 80% of lithium in LiCoO₂ having the O2 structure that belongs to the space group P6₃mc is deintercalated, charging and discharging can be performed. However, even in the case where LiCoO₂ specified by the O2 structure is used as a positive electrode active material, for example, when the nonaqueous electrolyte secondary battery is charged to about 4.6 V (vs. Li/Li⁺), the charge-discharge cycle characteristics of the battery can be degraded.

In contrast, in the positive electrode 12 of the nonaqueous electrolyte secondary battery 1 according to this embodiment, for example, even when the nonaqueous electrolyte secondary battery 1 is charged to a potential equal to or higher than 4.6 V (vs. Li/Li⁺) before use, the nonaqueous electrolyte secondary battery 1 can have improved charge-discharge cycle characteristics because the decomposition of the nonaqueous electrolyte is inhibited by the compound containing the element.

The nonaqueous electrolyte secondary battery 1 according to this embodiment is preferably charged to, in a fully charged state of the positive electrode 12, a potential of 4.6 V (vs. Li/Li⁺) or more and more preferably 4.7 V (vs. Li/Li⁺) or more before use. The nonaqueous electrolyte secondary battery 1 according to this embodiment is usually charged to, in a fully charged state of the positive electrode 12, a potential of 5.0 V (vs. Li/Li⁺) or less before use.

In the case where the nonaqueous electrolyte contains the fluorine-containing cyclic carbonate or the fluorine-containing chain ester, the decomposition of the nonaqueous electrolyte is further inhibited to further improve the charge-discharge cycle characteristics of the nonaqueous electrolyte secondary battery 1, which is preferred.

While the present invention will be described in more detail below by specific examples, the present invention is not limited to these examples. Appropriate changes may be made without departing from the gist of the invention.

### Example 1

### Production of Positive Electrode

Sodium nitrate (NaNO₃), cobalt(II) cobalt(III) oxide (Co₃O₄), and manganese(III) oxide (Mn₂O₃) were mixed together in a molar ratio of Na:Co:Mn of 0.7:(5/6):(1/6). The resulting mixture was held at 900° C. for 10 hours to give a sodium-containing transition metal oxide.

Five equivalents of a molten salt bed obtained by mixing lithium nitrate (LiNO₃) and lithium hydroxide (LiOH) in a molar ratio (mol %) of 61:39 was added to 5 g of the sodium-containing transition metal oxide. The mixture was held at 200° C. for 10 hours to ion-exchange part of sodium in the sodium-containing transition metal oxide for lithium. The resulting mixture was washed with water to provide lithium-containing transition metal oxide particles. The resulting lithium-containing transition metal oxide particles were analyzed by X-ray powder diffraction to identify crystal phases. The results demonstrated that the lithium-containing transition metal oxide particles exhibited a peak assigned to the O2 structure that belongs to the space group P6₃mc. The composition of the lithium-containing transition metal oxide particles was analyzed by ICP and identified to be Li_{0.8}Na_{0.033}Co_{0.84}Mn_{0.16}O₂.

The resulting lithium transition metal oxide particles were added to 2.0 L of pure water. The mixture was stirred to prepare a suspension. A solution of erbium nitrate pentahydrate dissolved in 100 mL of pure water was added to the suspension. To maintain the pH of the suspension to 9, 10% by mass of an aqueous solution of nitric acid and 10% by mass of aqueous solution of sodium hydroxide were appropriately added.

After the addition of the solution of erbium nitrate pentahydrate, the mixture was filtered by suction and washed with water to provide a powder. The powder was dried at 120° C. to provide particles in which a compound containing erbium hydroxide (hereinafter, also referred to simply as an “erbium compound”) was attached to surfaces of the lithium transition metal oxide particles. The particles were heat-treated at 200° C. for 5 hours in air. The resulting particles were analyzed by ICP. The results demonstrated that the amount of erbium hydroxide in the particles is 0.090% by mass in terms of elemental erbium. As described above, the particles in which the erbium compound (mainly hydroxide) was attached to the surfaces of the lithium-containing transition metal oxide particles serving as the positive electrode active material particles were produced.

Next, 95% by mass of the particles in which the erbium compound was attached to the surfaces of the lithium-containing transition metal oxide particles, 2.5% by mass of acetylene black, and 2.5% by mass of polyvinylidene fluoride were mixed together. N-Methyl-2-pyrrolidone was added thereto to form a slurry. The slurry was applied to aluminum foil. The slurry was dried at 110° C. into a positive electrode.

### Production of Negative Electrode

First, 90% by mass of polycrystalline silicon powder having an average particle diameter of 10 μm, 5% by mass of acetylene black, and 5% by mass of polyvinylidene fluoride were mixed together. N-Methyl-2-pyrrolidone was added to the resulting mixture to form a slurry. The slurry was applied to copper foil. The slurry was dried at 110° C. into a negative electrode.

### Production of Nonaqueous Electrolyte Secondary Battery

The positive electrode and the negative electrode produced as described above were rolled so as to face each other with a separator provided therebetween. The resulting roll was placed in a battery case. A nonaqueous electrolyte was injected thereinto in an Ar atmosphere. The battery case was sealed to provide a cylindrical nonaqueous electrolyte secondary battery having a height of 43 mm and a diameter of 14 mm. As the nonaqueous electrolyte, a 1.0 mol/L solution of lithium hexafluorophosphate (LiPF₆) in a nonaqueous solvent containing 4,5-difluoroethylene carbonate (DFEC), methyl 3,3,3-trifluoropropionate (F-MP), and methyl 2,2,2-trifluoroethylcarbonate (F-EMC) in a volume ratio of 20:70:10 was used.

### Evaluation of Cycle Characteristics

The resulting nonaqueous electrolyte secondary battery was charged at a constant current of 500 mA until the voltage reached 4.6 V. Furthermore, the battery was charged at a constant voltage of 4.6 V until the current value reached 50 mA. Then the battery was discharged at a constant current of 500 mA until the voltage reached 2.5 V, thereby measuring the charge-discharge capacity (mAh) of the battery. This charge-discharge operation was performed 25 cycles. The capacity maintenance ratio was measured to evaluate the cycle characteristics. Note that the capacity maintenance ratio is a value obtained by dividing the discharge capacity at the 25th cycle by the discharge capacity at the first cycle. Table 1 describes the results.

### Example 2

A nonaqueous electrolyte secondary battery was produced as in Example 1, except that a 1.0 mol/L solution of lithium hexafluorophosphate (LiPF₆) in a nonaqueous solvent containing 4,5-difluoroethylene carbonate (DFEC), methyl 3,3,3-trifluoropropionate (F-MP), and methyl 2,2,2-trifluoroethylcarbonate (F-EMC) in a volume ratio of 20:60:20 was used as the nonaqueous electrolyte. The evaluation of the cycle characteristics of the nonaqueous electrolyte secondary battery produced in Example 2 was performed in the same way as in Example 1. Table 1 describes the results.

### Example 3

A nonaqueous electrolyte secondary battery was produced as in Example 1, except that a 1.0 mol/L solution of lithium hexafluorophosphate (LiPF₆) in a nonaqueous solvent containing 4,5-difluoroethylene carbonate (DFEC) and methyl 3,3,3-trifluoropropionate (F-MP) in a volume ratio of 20:80 was used as the nonaqueous electrolyte. The evaluation of the cycle characteristics of the nonaqueous electrolyte secondary battery produced in Example 3 was performed in the same way as in Example 1. Table 1 describes the results.

### Example 4

A nonaqueous electrolyte secondary battery was produced as in Example 1, except that a 1.0 mol/L solution of lithium hexafluorophosphate (LiPF₆) in a nonaqueous solvent containing 4,5-difluoroethylene carbonate (DFEC) and methyl 3,3,3-trifluoropropionate (F-MP) in a volume ratio of 10:90 was used as the nonaqueous electrolyte. The evaluation of the cycle characteristics of the nonaqueous electrolyte secondary battery produced in Example 4 was performed in the same way as in Example 1. Table 1 describes the results.

### Example 5

A nonaqueous electrolyte secondary battery was produced as in Example 1, except that a 1.0 mol/L solution of lithium hexafluorophosphate (LiPF₆) in a nonaqueous solvent containing 4,5-difluoroethylene carbonate (DFEC) and methyl 3,3,3-trifluoropropionate (F-MP) in a volume ratio of 30:70 was used as the nonaqueous electrolyte. The evaluation of the cycle characteristics of the nonaqueous electrolyte secondary battery produced in Example 5 was performed in the same way as in Example 1. Table 1 describes the results.

### Example 6

A nonaqueous electrolyte secondary battery was produced as in Example 1, except that the mass of erbium hydroxide with respect to the total mass of erbium hydroxide and the lithium transition metal oxide particles was 0.20% by mass in terms of elemental erbium and that a 1.0 mol/L solution of lithium hexafluorophosphate (LiPF₆) in a nonaqueous solvent containing 4,5-difluoroethylene carbonate (DFEC), methyl 3,3,3-trifluoropropionate (F-MP), and methyl 2,2,2-trifluoroethylcarbonate (F-EMC) in a volume ratio of 20:70:10 was used as the nonaqueous electrolyte. The evaluation of the cycle characteristics of the nonaqueous electrolyte secondary battery produced in Example 6 was performed in the same way as in Example 1. Table 1 describes the results.

### Example 7

A nonaqueous electrolyte secondary battery was produced as in Example 6, except that a 1.0 mol/L solution of lithium hexafluorophosphate (LiPF₆) in a nonaqueous solvent containing 4,5-difluoroethylene carbonate (DFEC) and methyl 3,3,3-trifluoropropionate (F-MP) in a volume ratio of 20:80 was used as the nonaqueous electrolyte. The evaluation of the cycle characteristics of the nonaqueous electrolyte secondary battery produced in Example 7 was performed in the same way as in Example 1. Table 1 describes the results.

### Example 8

A nonaqueous electrolyte secondary battery was produced as in Example 6, except that a 1.0 mol/L solution of lithium hexafluorophosphate (LiPF₆) in a nonaqueous solvent containing 4,5-difluoroethylene carbonate (DFEC) and 2,2,2-trifluoroethyl acetate (F-EA) in a volume ratio of 20:80 was used as the nonaqueous electrolyte. The evaluation of the cycle characteristics of the nonaqueous electrolyte secondary battery produced in Example 8 was performed in the same way as in Example 1. Table 1 describes the results.

### Example 9

A nonaqueous electrolyte secondary battery was produced as in Example 3, except that the mass of erbium hydroxide with respect to the total mass of erbium hydroxide and the lithium transition metal oxide particles was 0.41% by mass in terms of elemental erbium. The evaluation of the cycle characteristics of the nonaqueous electrolyte secondary battery produced in Example 9 was performed in the same way as in Example 1. Table 1 describes the results.

### Example 10

A nonaqueous electrolyte secondary battery was produced as in Example 3, except that the mass of erbium hydroxide with respect to the total mass of erbium hydroxide and the lithium transition metal oxide particles was 0.82% by mass in terms of elemental erbium. The evaluation of the cycle characteristics of the nonaqueous electrolyte secondary battery produced in Example 10 was performed in the same way as in Example 1. Table 1 describes the results.

### Example 11

A nonaqueous electrolyte secondary battery was produced as in Example 3, except that particles in which a boron compound was attached to the surfaces of the lithium transition metal oxide particles in place of the erbium compound were produced by mixing an aqueous solution of boric acid (HB₃O₃) with the lithium transition metal oxide particles, drying the mixture at 80° C., grinding the mixture with a grinder, and firing the mixture at 200° C. for 10 hours. The amount of boric acid was adjusted in such a manner that the amount of boron in the particles to which the boron compound was attached was 2.0% by mass in terms of elemental boron. The evaluation of the cycle characteristics of the nonaqueous electrolyte secondary battery produced in Example 11 was performed in the same way as in Example 1. Table 1 describes the results.

### Comparative Example 1

A nonaqueous electrolyte secondary battery was produced as in Example 1, except that the erbium compound was not attached to the surfaces of the lithium-containing transition metal oxide particles. The evaluation of the cycle characteristics of the nonaqueous electrolyte secondary battery produced in Comparative Example 1 was performed in the same way as in Example 1. Table 1 describes the results.

### Comparative Example 2

A nonaqueous electrolyte secondary battery was produced as in Comparative Example 1, except that the a 1.0 mol/L solution of lithium hexafluorophosphate (LiPF₆) in a nonaqueous solvent containing 4,5-difluoroethylene carbonate (DFEC) and methyl 3,3,3-trifluoropropionate (F-MP) in a volume ratio of 20:80 was used as the nonaqueous electrolyte. The evaluation of the cycle characteristics of the nonaqueous electrolyte secondary battery produced in Comparative Example 2 was performed in the same way as in Example 1. Table 1 describes the results.

TABLE 1

| | | Percentage of element in | | Capacity |
|---|---|---|---|---|
| | Element in compound | compound attached to | | maintenance |
| | attached to surface of | surface of positive | | ratio (%) |
| | positive electrode | electrode active material | Nonaqueous | after 25 |
| | active material | (% by mass) | electrolyte | cycles |
| Example 1 | Er | 0.090 | 1M LiPF₆ DFEC/F-MP/ | 88.9 |
| | | | F-EMC (2/7/1) | |
| Example 2 | Er | 0.090 | 1M LiPF₆ DFEC/F-MP/ | 88.5 |
| | | | F-EMC (2/6/2) | |
| Example 3 | Er | 0.090 | 1M LiPF₆ DFEC/F-MP | 87.9 |
| | | | (2/8) | |
| Example 4 | Er | 0.090 | 1M LiPF₆ DFEC/F-MP | 88.8 |
| | | | (1/9) | |
| Example 5 | Er | 0.090 | 1M LiPF₆ DFEC/F-MP | 89.0 |
| | | | (3/7) | |
| Example 6 | Er | 0.200 | 1M LiPF₆ | 91.7 |
| | | | DFEC/F-MP/F-EMC | |
| | | | (2/7/1) | |
| Example 7 | Er | 0.200 | 1M LiPF₆ DFEC/F-MP | 89.4 |
| | | | (2/8) | |
| Example 8 | Er | 0.200 | 1M LiPF₆ DFEC/F-EA | 93.6 |
| | | | (2/8) | |
| Example 9 | Er | 0.410 | 1M LiPF₆ DFEC/F-MP | 91.2 |
| | | | (2/8) | |
| Example 10 | Er | 0.820 | 1M LiPF₆ DFEC/F-MP | 90.0 |
| | | | (2/8) | |
| Example 11 | B | 2.00 | 1M LiPF₆ DFEC/F-MP | 87.2 |
| | | | (2/8) | |
| Comparative | — | — | 1M LiPF₆ | 77.3 |
| Example 1 | | | DFEC/F-MP/F-EMC | |
| | | | (2/7/1) | |
| Comparative | — | — | 1M LiPF₆ DFEC/F-MP | 79.0 |
| Example 2 | | | (2/8) | |

As is clear from Table 1, all the nonaqueous electrolyte secondary batteries according to Examples 1 to 11 exhibit excellent charge-discharge cycle characteristics, compared with the nonaqueous electrolyte secondary batteries according to Comparative Examples 1 and 2. The reason for this is presumably that since the compound containing boron or erbium was attached to the surfaces of the lithium-containing transition metal oxide particles having the O2 structure that belongs to the space group P6₃mc, satisfactory coating films were formed on the lithium-containing transition metal oxide particles, thereby inhibiting the side reaction during charging and discharging.

The results of Examples 1 and 3 and Examples 6 and 7 demonstrated that an increase in the content of the element in the compound attached to the surfaces of the lithium-containing transition metal oxide particles further improves the cycle characteristics.

Comparisons between Examples 1 and 3 and between Examples 6 and 7 reveal that when the erbium-containing compound is attached, the use of the nonaqueous electrolyte containing methyl 2,2,2-trifluoroethylcarbonate (F-EMC) improves the capacity maintenance ratio. A comparison between Comparative Examples 1 and 2 reveals that when the erbium-containing compound is not attached to the surfaces of the lithium-containing transition metal oxide particles, the use of the nonaqueous electrolyte solvent containing methyl 2,2,2-trifluoroethylcarbonate (F-EMC) reduces the capacity maintenance ratio.

### Example 12

A nonaqueous electrolyte secondary battery was produced as in Example 6, except that a 1.0 mol/L solution of lithium hexafluorophosphate (LiPF₆) in a nonaqueous solvent containing 4-fluoroethylene carbonate (FEC) and methyl 3,3,3-trifluoropropionate (F-MP) in a volume ratio of 20:80 was used as the nonaqueous electrolyte. The evaluation of the cycle characteristics of the nonaqueous electrolyte secondary battery produced in Example 12 was performed in the same way as in Example 1. Table 2 describes the results.

### Comparative Example 3

A nonaqueous electrolyte secondary battery was produced as in Comparative Example 1, except that a 1.0 mol/L solution of lithium hexafluorophosphate (LiPF₆) in a nonaqueous solvent containing 4-fluoroethylene carbonate (FEC) and methyl 3,3,3-trifluoropropionate (F-MP) in a volume ratio of 20:80 was used as the nonaqueous electrolyte. The evaluation of the cycle characteristics of the nonaqueous electrolyte secondary battery produced in Comparative Example 3 was performed in the same way as in Example 1. Table 2 describes the results.

TABLE 2

| | | Percentage of element in | | Capacity |
|---|---|---|---|---|
| | Element in compound | compound attached to | | maintenance |
| | attached to surface of | surface of positive | | ratio (%) |
| | positive electrode | electrode active material | | after 25 |
| | active material | (% by mass) | Nonaqueous electrolyte | cycles |
| Example 12 | Er | 0.200 | 1M LiPF₆ FEC/F-MP | 79.5 |
| | | | (2/8) | |
| Comparative | | — | 1M LiPF₆ FEC/F-MP | — |
| Example 3 | | | (2/8) | |

In the nonaqueous electrolyte secondary battery produced in Comparative Example 3, the capacity maintenance ratio was reduced to 40.5% at 14th cycle, so the measurement of the capacity maintenance ratio was discontinued.

### Example 13

### Production of Negative Electrode

Graphite having an average particle diameter of 25 μm was used as the negative electrode active material. First, 98% by mass of the negative electrode active material, 1% by mass of carboxymethylcellulose (CMC) serving as a thickener, and 1% by mass of styrene-butadiene rubber serving as a binder were mixed with water into a slurry, the percentage being on a solid content basis. The resulting slurry was applied to a copper foil collector and dried at 110° C. to form a negative electrode.

### Production of Positive Electrode

A positive electrode was produced as in Example 1, except that the erbium content of the particles in which the erbium compound was attached to the surfaces of the lithium-containing transition metal oxide particles was 0.090% by mass in terms of elemental erbium.

### Production of Nonaqueous Electrolyte Secondary Battery

The negative electrode and the positive electrode produced in Example 13 were rolled so as to face each other with a separator provided therebetween. The resulting roll had a thickness of 3.6 mm, a width of 35 mm, and a height of 62 mm. The resulting roll was placed in an aluminum laminated case. A nonaqueous electrolyte was injected into the case in an Ar atmosphere. The battery case was sealed to provide a rectangular nonaqueous electrolyte secondary battery. As the nonaqueous electrolyte, a 1.0 mol/L solution of lithium hexafluorophosphate (LiPF₆) in a nonaqueous solvent containing 4-fluoroethylene carbonate (FEC) and methyl 3,3,3-trifluoropropionate (F-MP) in a volume ratio of 20:80 was used.

### Evaluation of Cycle Characteristics

The resulting nonaqueous electrolyte secondary battery produced in Example 13 was charged at a constant current of 500 mA until the voltage reached 4.65 V. Furthermore, the battery was charged at a constant voltage of 4.65 V until the current value reached 50 mA. Then the battery was discharged at a constant current of 500 mA until the battery voltage reached 2.75 V, thereby measuring the charge-discharge capacity (mAh) of the battery. This charge-discharge operation was performed 100 cycles. The capacity maintenance ratio was measured to evaluate the cycle characteristics. Note that the capacity maintenance ratio is a value obtained by dividing the discharge capacity at the 100th cycle by the discharge capacity at the first cycle. Table 3 describes the results.

### Example 14

Particles in which aluminum hydroxide was attached to surfaces of the lithium-containing transition metal oxide particles were produced in the same way as in Example 1, except that aluminum nitrate nonahydrate was used in place of erbium nitrate pentahydrate. The composition of the resulting particles was analyzed by ICP. The results demonstrated that the mass of aluminum with respect to the total mass of the lithium-containing transition metal oxide particles and aluminum hydroxide was 0.015% by mass in terms of elemental aluminum. This amount of aluminum is equivalent to the amount of erbium in Example 1 in terms of mole.

A rectangular nonaqueous electrolyte secondary battery was produced as in Example 13, except that the particles in which aluminum hydroxide was attached to the surfaces of the lithium-containing transition metal oxide particles were used. The evaluation of the cycle characteristics of the nonaqueous electrolyte secondary battery produced in Example 14 was performed in the same way as in Example 13. Table 3 describes the results.

### Example 15

Particles in which neodymium hydroxide was attached to surfaces of the lithium-containing transition metal oxide particles were produced in the same way as in Example 1, except that neodymium nitrate hexahydrate was used in place of erbium nitrate pentahydrate. The composition of the resulting particles was analyzed by ICP. The results demonstrated that the mass of neodymium with respect to the total mass of the lithium-containing transition metal oxide particles and neodymium hydroxide was 0.07% by mass in terms of elemental neodymium.

This amount of neodymium is equivalent to the amount of erbium in Example 1 in terms of mole.

A rectangular nonaqueous electrolyte secondary battery was produced as in Example 13, except that the particles in which neodymium hydroxide was attached to the surfaces of the lithium-containing transition metal oxide particles were used. The evaluation of the cycle characteristics of the nonaqueous electrolyte secondary battery produced in Example 15 was performed in the same way as in Example 13. Table 3 describes the results.

### Example 16

Particles in which samarium hydroxide was attached to surfaces of the lithium-containing transition metal oxide particles were produced in the same way as in Example 1, except that samarium nitrate hexahydrate was used in place of erbium nitrate pentahydrate. The composition of the resulting particles was analyzed by ICP. The results demonstrated that the mass of samarium with respect to the total mass of the lithium-containing transition metal oxide particles and samarium hydroxide was 0.08% by mass in terms of elemental samarium.

This amount of samarium is equivalent to the amount of erbium in Example 1 in terms of mole.

A rectangular nonaqueous electrolyte secondary battery was produced as in Example 13, except that the particles in which samarium hydroxide was attached to the surfaces of the lithium-containing transition metal oxide particles were used. The evaluation of the cycle characteristics of the nonaqueous electrolyte secondary battery produced in Example 16 was performed in the same way as in Example 13. Table 3 describes the results.

### Example 17

Particles in which terbium hydroxide was attached to surfaces of the lithium-containing transition metal oxide particles were produced in the same way as in Example 1, except that terbium nitrate hexahydrate was used in place of erbium nitrate pentahydrate. The composition of the resulting particles was analyzed by ICP. The results demonstrated that the mass of terbium with respect to the total mass of the lithium-containing transition metal oxide particles and terbium hydroxide was 0.08% by mass in terms of elemental terbium.

This amount of terbium is equivalent to the amount of erbium in Example 1 in terms of mole.

A rectangular nonaqueous electrolyte secondary battery was produced as in Example 13, except that the particles in which terbium hydroxide was attached to the surfaces of the lithium-containing transition metal oxide particles were used. The evaluation of the cycle characteristics of the nonaqueous electrolyte secondary battery produced in Example 17 was performed in the same way as in Example 13. Table 3 describes the results.

### Example 18

Particles in which holmium hydroxide was attached to surfaces of the lithium-containing transition metal oxide particles were produced in the same way as in Example 1, except that holmium nitrate pentahydrate was used in place of erbium nitrate pentahydrate. The composition of the resulting particles was analyzed by ICP. The results demonstrated that the mass of holmium with respect to the total mass of the lithium-containing transition metal oxide particles and holmium hydroxide was 0.08% by mass in terms of elemental holmium.

This amount of holmium is equivalent to the amount of erbium in Example 1 in terms of mole.

A rectangular nonaqueous electrolyte secondary battery was produced as in Example 13, except that the particles in which holmium hydroxide was attached to the surfaces of the lithium-containing transition metal oxide particles were used. The evaluation of the cycle characteristics of the nonaqueous electrolyte secondary battery produced in Example 18 was performed in the same way as in Example 13. Table 3 describes the results.

### Example 19

Particles in which lutetium hydroxide was attached to surfaces of the lithium-containing transition metal oxide particles were produced in the same way as in Example 1, except that lutetium nitrate trihydrate was used in place of erbium nitrate pentahydrate. The composition of the resulting particles was analyzed by ICP. The results demonstrated that the mass of lutetium with respect to the total mass of the lithium-containing transition metal oxide particles and lutetium hydroxide was 0.09% by mass in terms of elemental lutetium.

This amount of lutetium is equivalent to the amount of erbium in Example 1 in terms of mole.

A rectangular nonaqueous electrolyte secondary battery was produced as in Example 13, except that the particles in which lutetium hydroxide was attached to the surfaces of the lithium-containing transition metal oxide particles were used. The evaluation of the cycle characteristics of the nonaqueous electrolyte secondary battery produced in Example 19 was performed in the same way as in Example 13. Table 3 describes the results.

### Example 20

Particles in which cerium hydroxide was attached to surfaces of the lithium-containing transition metal oxide particles were produced in the same way as in Example 1, except that cerium nitrate hexahydrate was used in place of erbium nitrate pentahydrate. The composition of the resulting particles was analyzed by ICP. The results demonstrated that the mass of cerium with respect to the total mass of the lithium-containing transition metal oxide particles and cerium hydroxide was 0.07% by mass in terms of elemental cerium (cerium hydroxide changes into cerium oxide at 110° C.)

This amount of cerium is equivalent to the amount of erbium in Example 1 in terms of mole.

A rectangular nonaqueous electrolyte secondary battery was produced as in Example 13, except that the particles in which cerium oxide was attached to the surfaces of the lithium-containing transition metal oxide particles were used. The evaluation of the cycle characteristics of the nonaqueous electrolyte secondary battery produced in Example 20 was performed in the same way as in Example 13. Table 3 describes the results.

### Comparative Example 4

A rectangular nonaqueous electrolyte secondary battery was produced as in Example 13, except that erbium was not attached. The evaluation of the cycle characteristics of the nonaqueous electrolyte secondary battery produced in Comparative Example 4 was performed in the same way as in Example 13. Table 3 describes the results.

TABLE 3

| | Element in compound | |
|---|---|---|
| | attached to surface of positive | Capacity maintenance |
| | electrode active material | ratio (%) after 100 cycles |
| Example 13 | Er | 86 |
| Example 14 | Al | 76 |
| Example 15 | Nd | 83 |
| Example 16 | Sm | 85 |
| Example 17 | Tb | 79 |
| Example 18 | Ho | 80 |
| Example 19 | Lu | 80 |
| Example 20 | Ce | 60 |
| Comparative | — | 51 |
| Example 4 | | |

As is clear from Table 3, the nonaqueous electrolyte secondary batteries according to Examples 13 to 20 exhibit excellent cycle characteristics, compared with the nonaqueous electrolyte secondary batteries according to Comparative Example 4. The attachment of the compounds of the rare-earth elements of erbium, neodymium, samarium, terbium, holmium, and lutetium results in excellent cycle characteristics, compared with the attachment of cerium oxide, which is a rare-earth compound, and aluminum oxide. In particular, when erbium, neodymium, and samarium are attached, excellent cycle characteristics are provided.

### Example 21

### Production of Negative Electrode

As a negative electrode, metallic lithium cut into a piece having a predetermined size was used. Furthermore, metallic lithium was cut into a predetermined size, preparing a reference electrode.

### Production of Positive Electrode

Sodium nitrate (NaNO₃), cobalt(II) cobalt(III) oxide (Co₂O₄), titanium dioxide (TiO₂), and manganese(III) oxide (Mn₂O₂) were mixed together in a molar ratio of Na:Co:Ti:Mn of 0.7:(8/9):(1/27):(2/27). The resulting mixture was held at 900° C. for 10 hours to give a sodium-containing transition metal oxide. The resulting sodium-containing transition metal oxide was subjected to ion exchange and washing with water in the same way as in Example 1, thereby providing lithium-containing transition metal oxide particles. ICP measurement revealed that the composition of the particles was Li_{0.83}Na_{0.038}Co_{0.891}Ti_{0.035}Mn_{0.074}O₂.

Particles in which an erbium compound was attached to the surfaces of the lithium-containing transition metal oxide particles were produced as in Example 1, except that the lithium-containing transition metal oxide particles were used and that the mass of erbium with respect to the total mass of the erbium compound was 0.17% by mass in terms of elemental erbium.

### Production of Electrolytic Solution

A 1.0 mol/L solution of lithium hexafluorophosphate (LiPF₆) in a nonaqueous solvent containing 4-fluoroethylene carbonate (FEC) and methyl 3,3,3-trifluoropropionate (F-MP) in a volume ratio of 20:80 was used as a nonaqueous electrolyte (1 M LiPF₆ FEC:FMP=20:80).

### Production of Cell

In an inert atmosphere, a test cell in Example 21, as illustrated in FIG. 3, was produced as follows: The foregoing positive electrode 22 was used as a working electrode. A negative electrode 21 serving as a counter electrode and a reference electrode 23 were each composed of metallic lithium. The foregoing nonaqueous electrolyte 25 was injected. Reference numeral 24 denotes separators. Reference numeral 27 denotes lead lines.

### Charge-Discharge Test

An initial charge-discharge test was performed as follows. Constant-current charge was performed at a current density of 36 mA/g until the potential of the working electrode with respect to the reference electrode (metallic Li) reached 4.8 V. After 10 minutes of suspension, constant-current discharge was performed at a current density of 36 mA/g until the potential of the working electrode with respect to the reference electrode composed of metallic Li reached 3.2 V. After the completion of the initial charge-discharge test, a cycle test was performed by repeating the charge-discharge operation 30 cycles under the foregoing conditions. The discharge capacity maintenance ratio at 30th cycle was determined from 30th discharge capacity/initial discharge capacity×100.

Note that the initial charge-discharge test and the cycle test were performed at 25° C.±5° C.

### Example 22

Particles in which zirconium hydroxide was attached to surfaces of the lithium-containing transition metal oxide particles were produced in the same way as in Example 21, except that zirconium oxyacetate was used in place of erbium nitrate pentahydrate. The composition of the resulting particles was analyzed by ICP. The results demonstrated that the mass of zirconium with respect to the total mass of the lithium-containing transition metal oxide particles and zirconium hydroxide was 0.09% by mass in terms of elemental zirconium.

This amount of zirconium is equivalent to the amount of erbium in Example 21 in terms of mole.

A nonaqueous electrolyte secondary battery was produced as in Example 21, except that the particles in which zirconium hydroxide was attached to the surfaces of the lithium-containing transition metal oxide particles were used. The evaluation of the cycle characteristics of the nonaqueous electrolyte secondary battery produced in Example 22 was performed in the same way as in Example 21. Table 4 describes the results.

### Example 23

Particles in which magnesium hydroxide was attached to surfaces of the lithium-containing transition metal oxide particles were produced in the same way as in Example 21, except that magnesium nitrate hexahydrate was used in place of erbium nitrate pentahydrate. The composition of the resulting particles was analyzed by ICP. The results demonstrated that the mass of magnesium with respect to the total mass of the lithium-containing transition metal oxide particles and magnesium hydroxide was 0.025% by mass in terms of elemental magnesium.

This amount of magnesium is equivalent to the amount of erbium in Example 21 in terms of mole.

A test cell was produced as in Example 21, except that the particles in which magnesium hydroxide was attached to the surfaces of the lithium-containing transition metal oxide particles were used. The evaluation of the cycle characteristics of the test cell produced in Example 22 was performed in the same way as in Example 21. Table 4 describes the results.

### Comparative Example 5

A cell was produced as in Example 21, except that the positive electrode produced in Comparative Example 1 was used. The evaluation of the cycle characteristics of the nonaqueous electrolyte secondary battery produced in Comparative Example 5 was performed as in Example 21. Table 4 describes the results.

TABLE 4

| | | Capacity | |
|---|---|---|---|
| | Element in compound | maintenance | |
| | attached to surface of | ratio | |
| | positive electrode | (%) after | |
| | active material | 30 cycles | Electrolytic solution |
| Example 21 | Er | 87 | 1M LiPF₆ |
| | | | FEC:FMP = 20:80 |
| Example 22 | Zr | 84 | 1M LiPF₆ |
| | | | FEC:FMP = 20:80 |
| Example 23 | Mg | 82 | 1M LiPF₆ |
| | | | FEC:FMP = 20:80 |
| Comparative | — | 79 | 1M LiPF₆ |
| Example 5 | | | FEC:FMP = 20:80 |

As is clear from Table 4, the test cells according to Examples 21 to 23 exhibit excellent cycle characteristics, compared with the test cell according to Comparative Example 5. The reason for this is presumably that since the compound containing erbium, zirconium, or magnesium was attached, satisfactory coating films were formed on the lithium-containing transition metal oxide particles, thereby inhibiting the side reaction during charging and discharging.

### Example 24

A nonaqueous electrolyte secondary battery was produced as in Example 14.

### Comparative Example 6

A nonaqueous electrolyte secondary battery was produced as in Example 24, except that lithium cobaltate having the O3 structure (Mg and Al were each dissolved in an amount of 1.0% by mole, and 0.04% by mole of Zr was contained) was used as a positive electrode material in place of lithium cobaltate having the O2 structure.

### Comparative Example 7

A rectangular nonaqueous electrolyte secondary battery was produced as in Example 24, except that aluminum hydroxide was not attached.

### Comparative Example 8

A rectangular nonaqueous electrolyte secondary battery was produced as in Comparative Example 6, except that aluminum hydroxide was not attached.

### Evaluation of Cycle Characteristics

Each of the resulting nonaqueous electrolyte secondary batteries was charged at a constant current of 500 mA until the battery voltage reached 4.60 V (4.70 V with respect to metallic lithium). Furthermore, the battery was charged at a constant voltage of 4.60 V until the current value reached 50 mA. Then the battery was discharged at a constant current of 500 mA until the battery voltage reached 2.75 V, thereby measuring the charge-discharge capacity (mAh) of the battery.

Measurement was performed until the discharge capacity maintenance ratio reached 80%. The number of cycles at a discharge capacity maintenance ratio of 80% was determined. Table 5 describes the results.

TABLE 5

| | Element | Number | |
|---|---|---|---|
| | in compound | of cycles upon | |
| | attached to surface | reaching discharge | |
| | of positive electrode | capacity maintenance | Type of |
| | active material | ratio of 80% | structure |
| Example 24 | Al | 95 | O2 structure |
| Comparative | Al | 10 | O3 structure |
| Example 6 | | | |
| Comparative | — | 60 | O2 structure |
| Example 7 | | | |
| Comparative | — | 9 | O3 structure |
| Example 8 | | | |

As described in Table 5, a comparison between Comparative Examples 6 and 8, in which the positive electrode active material having the O3 structure was used, revealed that even if the aluminum compound was attached to the surfaces, the cycle characteristics were little improved. A comparison between Example 24 and Comparative Example 7, in which the positive electrode active material having the O2 structure was used, revealed that the cycle characteristics were significantly improved in Example 24 in which the aluminum compound was attached to the surfaces, compared with Comparative Example 7 in which the aluminum compound was not attached to the surfaces. This is because in the case of lithium cobaltate having the O3 structure in Comparative Examples 6 and 8, when the charge voltage is 4.6 V, the structure degrades rapidly. In contrast, in the case of lithium cobaltate having the O2 structure described in Examples 24 and Comparative Example 7, even when the charge voltage is 4.6 V, the structure is less likely to degrade. It is believed that as described in Example 24, the aluminum hydroxide is attached to the surface of the positive electrode active material, so that a satisfactory coating film was formed on the surface of the positive electrode active material to inhibit the side reaction during the charging and discharging, thereby improving the cycle characteristics.

### Example 25

Particles in which the erbium compound was attached to the surfaces of the lithium-containing transition metal oxide particles were produced as in Example 1, except that the amount of erbium nitrate pentahydrate was 0.6 times that in Example 1. The composition of the resulting particles was analyzed by ICP. The results demonstrated that the mass of erbium with respect to the total mass of the lithium-containing transition metal oxide particles and the erbium compound was 0.048% by mass. A test cell was produced as in Example 21. The cycle test was performed under the same conditions as in Example 21. Table 6 describes the results.

### Example 26

A cell was produced as in Example 25, except that a solvent mixture of ethylene carbonate (EC) and diethyl carbonate (DEC) mixed in a volume ratio of 20:80 was used in place of the FEC-FMP (20:80) solvent mixture as the nonaqueous solvent. The evaluation of the cycle characteristics of the nonaqueous electrolyte secondary battery was performed as in Example 25. Table 6 describes the results.

TABLE 6

| | | Number of cycles |
|---|---|---|
| | | upon reaching discharge |
| | | capacity maintenance |
| | Electrolytic solution | ratio of 90% |
| Example 25 | 1M LiPF₆ FEC:FMP = 20:80 | 20 |
| Example 26 | 1M LiPF₆ EC:DEC = 20:80 | 12 |

As described in Table 6, in Example 25 in which the solvent mixture of FEC and FMP was used as the nonaqueous solvent, the cycle characteristics are improved, compared with the Example 26 in which the solvent mixture of EC and DEC was used as the nonaqueous solvent. The reason for this is presumably that the use of the fluorine-based solvent as the nonaqueous solvent inhibits the decomposition reaction of the electrolytic solution on the surfaces of the lithium-containing transition metal oxide particles and inhibits the associated degradation of the positive electrode.

### Study of pH Control

We have conducted studies on the effect of controlling the pH upon adding a solution of a salt of a compound to the dispersion of the positive electrode active material particles.

### Examples 27 to 30

Test cells were produced as in Example 21, except that when the solution of erbium nitrate pentahydrate was added to the dispersion (suspension) of the lithium transition metal oxide particles, the pH was controlled to predetermined pH values (pH=6 in Example 27, pH=7 in Example 28, pH=10 in Example 29, and pH=12 in Example 30) by the appropriate addition of 10% by mass of an aqueous solution of nitric acid and 10% by mass of aqueous solution of sodium hydroxide. The evaluation results are described in Table 7.

TABLE 7

| | | Cycle characteristics |
|---|---|---|
| | Attachment | Capacity |
| | treatment | maintenance ratio (%) |
| | control pH | after 30 cycle |
| Example 27 | 6 | 80 |
| Example 28 | 7 | 86 |
| Example 21 | 9 | 87 |
| Example 29 | 10 | 87 |
| Example 30 | 12 | 84 |
| Comparative | — | 79 |
| Example 5 | | |

As is clear from the results described in Table 7, the pH in the attachment treatment is preferably controlled in the range of 7 to 12 and more preferably 7 to 10.

It is believed that at a pH of 6, although the compound is attached to the surfaces of the active material particles, cobalt in the positive electrode active material is eluted because the dispersion is slightly acidic; hence, the surfaces are degraded to reduce the characteristics.

A pH of 12 may cause the segregation of the compound on the surfaces of the active material particles, thereby reducing the coating effect of the compound.

### REFERENCE SIGNS LIST

1 nonaqueous electrolyte secondary battery
10 electrode member
11 negative electrode
12 positive electrode
12a positive electrode collector
12b positive electrode active material layer
13 separator
17 battery case
21 negative electrode
22 positive electrode
23 reference electrode
24 separator
25 nonaqueous electrolyte
26 laminated case
27 lead line

1. A positive electrode for a nonaqueous electrolyte secondary battery, the positive electrode comprising:
positive electrode active material particles,
wherein the positive electrode active material particles contain a lithium-containing transition metal oxide having a crystal structure that belongs to the space group P6₃mc, and
a compound containing at least one selected from the group consisting of boron, zirconium, aluminum, magnesium, titanium, and a rare-earth element is attached to surfaces of the positive electrode active material particles.

2. The positive electrode for a nonaqueous electrolyte secondary battery according to claim 1, wherein the compound containing at least one selected from the group consisting of boron, zirconium, aluminum, magnesium, titanium, and the rare-earth element is attached to the surfaces of the positive electrode active material particles and is in the form of at least one selected from the group consisting of hydroxide, oxyhydroxide, carbonate compounds, and phosphate compounds.

3. The positive electrode for a nonaqueous electrolyte secondary battery according to claim 1, wherein the rare-earth element is at least one selected from the group consisting of neodymium, samarium, terbium, holmium, erbium, and lutetium.

4. The positive electrode for a nonaqueous electrolyte secondary battery according to claim 1, wherein at least one selected from the group consisting of erbium hydroxide, erbium oxyhydroxide, and aluminum hydroxide is attached to the surfaces of the positive electrode active material particles.

5. The positive electrode for a nonaqueous electrolyte secondary battery according to claim 1, wherein the lithium-containing transition metal oxide contains, in its crystal, at least one selected from Mn and Ti.

6. A method for producing the positive electrode active material according to claim 1, the method comprising the steps of:
preparing a dispersion of the positive electrode active material particles dispersed in water; and
attaching the compound to the surfaces of the positive electrode active material particles by mixing a solution in which a salt containing at least one selected from the group consisting of zirconium, aluminum, magnesium, and rare-earth elements is dissolved, with the dispersion while the pH is controlled.

7. The method for producing the positive electrode active material according to claim 6, wherein the pH is controlled in the range of 7 to 10.

8. The method for producing the positive electrode active material according to claim 6, wherein the positive electrode active material in which the compound is attached to the surfaces of the positive electrode active material particles is heat-treated at 300° C. or lower.

9. A nonaqueous electrolyte secondary battery comprising the positive electrode for a nonaqueous electrolyte secondary battery according to claim 1, a negative electrode, a nonaqueous electrolyte, and a separator.

10. The nonaqueous electrolyte secondary battery according to claim 9, wherein the nonaqueous electrolyte contains at least one of a fluorine-containing cyclic carbonate and a fluorine-containing chain ester.

11. The nonaqueous electrolyte secondary battery according to claim 10, wherein the fluorine-containing cyclic carbonate is at least one of 4-fluoroethylene carbonate and 4,5-difluoroethylene carbonate.

12. The nonaqueous electrolyte secondary battery according to claim 10 or 11, wherein the fluorine-containing chain ester is at least one of a fluorine-containing chain carboxylate and a fluorine-containing chain carbonate.

13. The nonaqueous electrolyte secondary battery according to claim 12, wherein the fluorine-containing chain carboxylate is at least one of methyl 3,3,3-trifluoropropionate and 2,2,2-trifluoroethyl acetate.

14. The nonaqueous electrolyte secondary battery according to claim 12, wherein the fluorine-containing chain carbonate is methyl 2,2,2-trifluoroethyl carbonate.

15. The nonaqueous electrolyte secondary battery according to claim 9, wherein the nonaqueous electrolyte contains 1% by volume to 40% by volume methyl 2,2,2-trifluoroethyl carbonate.

16. The nonaqueous electrolyte secondary battery according to claim 9, wherein the nonaqueous electrolyte secondary battery is charged to a potential of 4.6 V (vs. Li/Li⁺) or more before use.
